(19) United States
(12) Patent Application Publication
(10) Pub. No.: US 2017/0241324 A1
(43) Pub. Date: Aug. 24, 2017

(54) THERMAL MANAGEMENT SYSTEM WITH HEAT RECOVERY AND METHOD OF MAKING AND USING THE SAME

(71) Applicant: BorgWarner Inc., Auburn Hills, MI (US)

(72) Inventor: Xiaobing LIU, Rochester Hills, MI (US)

(73) Assignee: BorgWarner Inc., Auburn Hills, MI (US)

(21) Appl. No.: 15/504,082

(22) PCT Filed: Aug. 11, 2015
(86) PCT No.: PCT/US2015/044631

§ 371 Date: Feb. 15, 2017

Related U.S. Application Data
(60) Provisional application No. 62/040,025, filed on Aug. 21, 2014.

(51) Int. Cl. F01P 7/16; F02N 19/10; F01P 5/10

(52) U.S. Cl. CPC F01P 7/16; F01P 5/10; F02N 19/10

(57) ABSTRACT

A number of variations may include a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump after engine start up to limit coolant temperature below a predetermined value in and/or near the exhaust heat recovery system.

### CROSS-REFERENCE TO RELATED APPLICATIONS

This application claims the benefit of U.S. Provisional Application No. 62/040,025 filed Aug. 21, 2014.

### TECHNICAL FIELD

The field to which the disclosure generally relates to includes thermal management system and heat recovery components in systems.

### BACKGROUND

Thermal management system and heat recovery components may be used in a variety of applications including, but not limited to, vehicle engines and components thereof.

### SUMMARY OF ILLUSTRATIVE VARIATIONS OF THE INVENTION

A number of variations may include a product having a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump to limit coolant temperature below a predetermined value in and/or near the exhaust heat recovery system.

A number of variations may include a method including providing a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump to limit coolant temperature below a predetermined value in and/or near the exhaust heat recovery system.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 illustrates a product including thermal management system according to a number of variations.

FIG. 2 illustrates a product including thermal management system according to a number of variations.

FIG. 3 illustrates a product including thermal management system according to a number of variations.

FIG. 4 illustrates a method according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

In a number of variations, a thermal management system may be used to manage heat in a system such as, but not limited to, a vehicle engine. In a number of variations, the thermal management system may include a fluid that may be routed through the thermal management system by a pump. In a number of variations, the pump may be a dual-mode coolant pump. In a number of variations, the dual-mode coolant pump may have two modes of operation including a first mechanical mode driven by an engine accessory belt, and a second electrical mode driven by an electric motor. In a number of variations, the components for the two modes of operation may be contained within a housing that includes the pulley assembly which may be part of the housing. In a number of variations, a shaft connected to the impeller of the pump may be positioned in the housing and may be controlled by one mode of operation or the other or both, depending on certain factors. In a number of variations, the shaft may rotate based on power supplied from the engine. In a number of variations, the shaft may rotate based on power form the electric motor. In a number of variations, the shaft may rotate based on power from both the engine and the electric motor. In a number of variations, a friction clutch member may be provided inside the housing to selectively drive the pump mechanically by the pulley member. In a number of variations, a solenoid may be utilized to control operation of the friction clutch. In a number of variations, the electric motor may be a brushless DC (BLDC) electric motor. In a number of variations, the pump may be adapted to be driven mechanically by the engine belt attached to a crankshaft of the engine. In a number of variations, the dual-mode coolant pump may be driven independently of the engine. In a number of variations, the dual-mode coolant pump may operate while the engine may be shut off through the electric motor. In a number of variations, the dual-mode coolant pump may be operated by an electronic control unit (ECU). In a number of variations, sensors may feed an electronic control unit which sends a signal to the pump to determine desired speed using the electric motor and/or by engaging the clutch member and driving the pump from the pulley member. In a number of variations, the electric motor may be able to provide “over-drive” where the pump can be spun at speeds greater than mechanical engine input speed from the engine. A non-limiting example of a dual-mode coolant pump may be found in U.S. application Ser. No. 13/473,577.

In a number of variations, the thermal management system may include an exhaust heat recovery system. In a number of variations, the exhaust heat recovery system may be used to extract heat energy dissipated by the engine for recycle to heat other vehicle components. In a number of variations, the engine may give off heat in its exhaust stream during engine operation. In a number of variations, the exhaust heat recovery system may transfer the exhaust heat from the exhaust stream to a fluid or coolant used in circuit in the thermal management system. In a number of variations, the transferred heat to the engine coolant may improve coolant and oil warm up during engine start up which decreases engine warm up time and increases engine efficiency. In a number of variations, the exhaust heat recovery system may include at least one heat exchanger. In a number of variations, the latent heat of the exhaust stream may be transferred to the coolant in the circuit of the thermal management system. In a number of variations, the coolant may transfer heat from the exhaust stream to other thermal management system components through subsequent heat transfers. In a number of variations, the coolant may be controlled to be under a certain temperature that may be the coolant boiling point. In a number of variations, coolant boiling point may be 120° C. In a number of variations, the thermal management system may include a bypass valve for fluid or coolant to limit flow into or bypass entirely the exhaust heat recovery system. In a number of variations, the thermal management system may include an exhaust gas bypass valve for exhaust gas to limit flow into or bypass entirely the exhaust heat recovery system. In a number of variations, the bypass valves may be operated by an electronic control unit (ECU). In a number of variations, sensors may feed an electronic control unit which sends a signal to the bypass valve to determine desired flowrate of fluid, exhaust gas, and/or coolant into the exhaust heat recovery system based on a number of predetermined conditions. In a number of variations, the ECU may control or limit coolant or fluid flow or exhaust gas flow into the exhaust heat recovery system to maximize engine efficiency or minimize heat loss during engine start up or operation. A non-limiting example of an exhaust heat recovery system may be found in U.S. application Ser. No. 13/086,386.

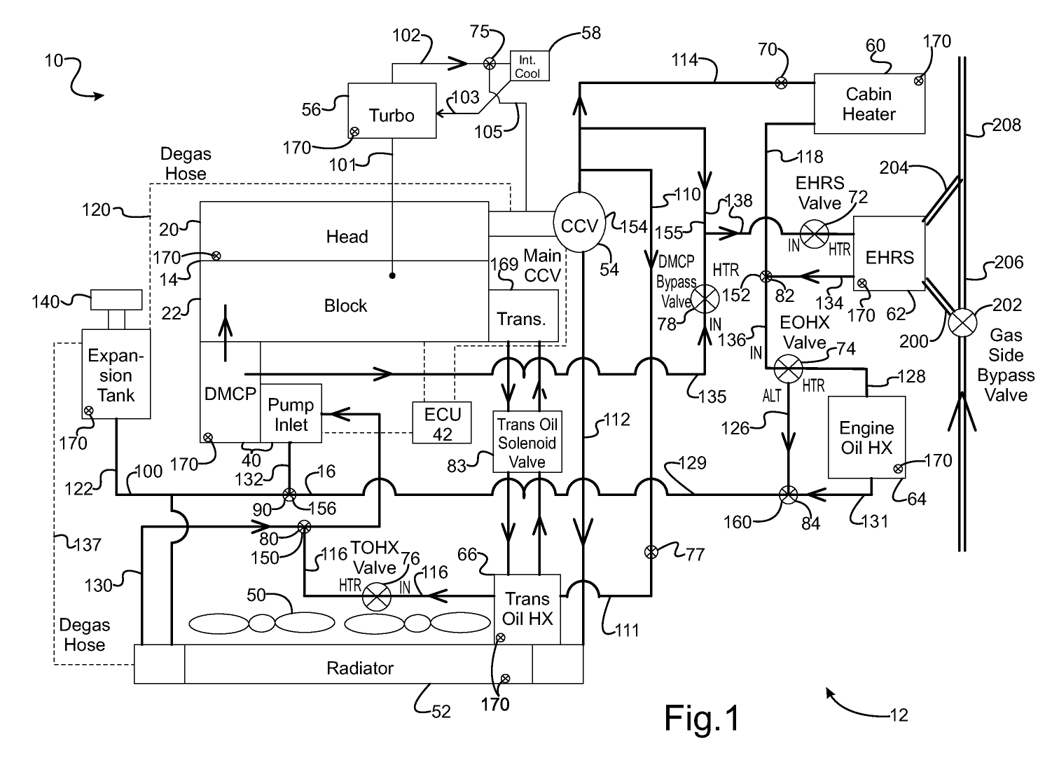

FIG. 1 illustrates a number of variations. In a number of variations, a product 10 is shown. In a number of variations, the product 10 may include a vehicle such as, but not limited to, a motor vehicle, watercraft, spacecraft, aircraft, or may be another type. In a number of variations, the product 10 may include a thermal management system 12. In a number of variations, the thermal management system 12 may include an engine 14. In a number of variations, the engine 14 may be an internal combustion engine, an external combustion engine, an electric motor, a hybrid engine, or may be another type. In a number of variations, the engine 14 may include an engine head 20 and an engine block 22. In a number of variations, the thermal management system 12 may include components such as, but not limited to, a transmission 169, a cooling fan 50, a radiator 52, a thermostat 54, a turbocharger 56, an expansion tank 140, a transmission oil heat exchanger 66, an engine oil heat exchanger 64, an exhaust heat recovery system 62, and/or a cabin heater 60. In a number of variations, the thermal management system 12 may include a coolant system 16. In a number of variations, the coolant system 16 may include a coolant 30. In a number of variations, the coolant 30 may be a fluid and may include, but is not limited to, air, water, oil, antifreeze (such as water and glycol), rust inhibitor, or a combination thereof. In a number of variations, the coolant system 16 may include a circuit 100 to route coolant through various components of the thermal management system 12. In a number of variations, the coolant system 16 may include a pump 40 to circulate the coolant 30 through the coolant system 16. In a number of variations, the pump 40 may have a speed (RPM) or flow-rate of coolant sent through the coolant system 16. In a number of variations, the pump 40 speed may be driven by the engine 14. In a number of variations, the pump 40 speed may be driven independently of the engine 14. In a number of variations, the pump 40 speed may be independently controlled as an electric pump or a dual mode coolant pump (DMCP). In a number of variations, an independent electronic control unit (ECU) 42 may control the speed of coolant 30 through the coolant system by controlling pump 40 speed. In a number of variations, the ECU 42 may accumulate data from a number of sensors (only sensor 170 shown for clarity) or sources in order to operate and regulate various systems of the thermal management system 12, engine 14, and/or coolant system 16. The sensors can be used to measure temperatures of fluids or components, pressures, flowrate or speeds (e.g. RPM), heat transfer rates, and the like. In a number of variations, the ECU 42 may take this data and optimize the thermal management system 12 to minimize fuel usage, maximize engine efficiency and/or minimize heat waste. In a number of variations, the ECU 42 may be constructed and arranged to operate the coolant pump after engine start up to limit coolant temperature below a predetermined value in and/or near the exhaust heat recovery system.

As shown in FIG. 1, in a number of variations, coolant 30 may flow through the pump 40 into the engine 14 through the engine block 22 and engine head 20. In a number of variations, the thermal management system 12 may also include a turbocharger 56 that forces air into the engine. In a number of variations, the turbocharger 56 may take in coolant from line 101 and coolant may exit the turbocharger 56 through line 102. In a number of variations, the turbocharger 56 may provide additional heat to the coolant 30 of the coolant system 16. In a number of variations, the turbocharger may include an intercooler 58. In a number of variations, the coolant 30 may enter the intercooler 58 through line 102 and be cooled. In a number of variations, the coolant 30 cooled from the intercooler 58 may exit the intercooler 58 and reenter the turbocharger 56. In a number of variations, the coolant system 16 may include a thermostat (and/or main Coolant Control Valve (CCV)) 54 to control coolant flow 30 to various components within the thermal management system 12. In a number of variations, the thermostat 54 may include an additional coolant control valve 154 to control coolant flow 30 to various components within the thermal management system 12 when the thermostat is closed. In a number of variations, the thermostat 54 and/or coolant control valve 154 may be controlled by the ECU 42. In a number of variations, the coolant 30 may at least bypass the intercooler 58 through an intercooler valve 75 into a thermostat 54 and/or CCV 154 through line 105. In a number of variations, coolant may leave the engine 14 and or turbocharger 56 and enter into the thermostat 54 and/or CCV 154. In a number of variations, the thermostat 54 and/or CCV 154 may allow coolant flow 30 to a cabin heater 60. In a number of variations, the thermostat 54 and/or CCV 154 may allow coolant flow 30 to an exhaust heat recovery system (EHRS) 62. In a number of variations, the thermostat 54 and/or CCV 154 may allow coolant flow 30 to an engine oil heat exchanger 64. In a number of variations, the thermostat 54 and/or CCV 154 may allow coolant flow to a transmission oil heat exchanger 66. In a number of variations, the thermostat 54 and/or CCV 154 may allow coolant flow to an axle oil heat exchanger 68. A skilled artisan would understand these components and their uses. In a number of variations, the cabin heater 60 may include at least one cabin heater valve 70 to allow or restrict coolant 30 flow to or from this component. In a number of variations, the EHRS 62 may include at least one EHRS valve 72 to allow or restrict coolant 30 flow to or from this component. In a number of variations, the engine oil heat exchanger 64 may include at least one engine oil heat exchanger valve 74 to allow or restrict coolant 30 flow to or from this component. In a number of variations, the transmission oil heat exchanger 66 may include at least one transmission oil heat exchanger valve 76 to allow or restrict coolant 30 flow to or from this component. In a number of variations, the axle oil heat exchanger 68 may include at least one axle oil heat exchanger valve 79 to allow or restrict coolant 30 flow to or from this component. In a number of variations, coolant 30 flow from the thermostat 54 and/or CCV 154 may allow flow to the cabin heater 60, EHRS 62, engine oil heat exchanger 64, axle oil heat exchanger 68, and/or transmission oil heat exchanger 66 at different ratios. In a number of variations the dual mode pump (DMCP) 40 may be mechanically connected to the engine and may have an electric motor (for example, a brushless DC motor) constructed and arranged to supplement the mechanical power provide by the engine or to operate independently of the mechanical link to the engine. The exhaust heat recovery system (EHRS) 62 may include thermal transfer components constructed and arranged to convert thermal losses in the exhaust system into usable energy.

Still referring to FIG. 1, in a number of variations, at engine start-up or normal operation, the coolant pump 40 may circulate coolant 30 through the engine 14, and after circulating through the engine 14, the coolant 30 passes from the engine 14 to the thermostat 54 and CCV 154. In a number of variations, when the engine may be cold, as during start-up, the thermostat 54 may be closed and the coolant 30 may be routed the coolant 30 from the engine 14 may be routed to one of the vehicle components such as the cabin heater 60, the EHRS 62, the engine oil heat exchanger 64, and or the axle oil heat exchanger 68. In a number of variations, when the engine 14 may be cold, the thermostat 54 may be closed and the coolant 30 may be routed through the line 135 into a DMCP bypass valve 78, to line 138 through a EHRS valve 72, into a EHRS 62, out of the EHRS 62 through line 134, through a secondary junction 152 with a secondary valve 82, through line 136, past a engine oil heat exchanger valve 74, to line 126, to a tertiary junction 160 and a tertiary valve 84, and back to the pump through line 129 to an intermediate junction 156 and an intermediate pump 90 to line 132. When the engine 14 and coolant 30 may be warmer and/or the engine may be in normal operation, the thermostat 54 may at least partially open and route the coolant 30 through line 112 to the radiator 54 and back to the pump 40 through line 130. In a number of variations, the thermostat 54 may be controlled by the amount of heat of the engine 14 or coolant 30. In a number of variations, the thermostat 54 may at least partially open when the coolant 30 temperature is above a threshold. In a number of variations, the coolant 30 temperature threshold may be about 85° C. In a number of variations, coolant 30 may escape the engine 14 through a degas hose 120 to an expansion tank 140 then through a line 122 back to the pump 40 through an intermediate junction 156 (including an intermediate valve 90) and line 132. In a number of variations, coolant 30 may escape the radiator 52 through a degas hose 137 to an expansion tank 140 then through a line 122 back to the pump 40 through an intermediate junction 156 (including an intermediate valve 90) and line 132.

In a number of variations the coolant 30 may be routed past the closed or at least partially open thermostat 54 through the coolant control valve 154 in hot or cold engine 14 conditions where the coolant 30 may pass through line 110, through a first transmission oil heat exchanger valve 77, into line 111, through a transmission oil heat exchanger 66 and through a second transmission oil heat exchanger valve 76 and through line 116. In a number of variations, line 116 may form a primary junction 150 with line 130 to route coolant 30 back to the pump 40. In a number of variations, the primary junction 150 may include a primary valve 80. In a number of variations, the coolant 30 may be routed past the closed or at least partially open thermostat 54 through the coolant control valve 154 in hot or cold engine 14 conditions where the coolant 30 may pass through a cabin heater line 114 and a cabin heater valve 70 and to a cabin heater 60. In a number of variations, the coolant 30 may be routed past the closed or at least partially open thermostat 54 through the coolant control valve 154 in hot or cold engine 14 conditions where the coolant 30 may pass through an exhaust heat recovery system line 138 and an exhaust heat recovery system valve 72 and to an exhaust heat recovery system 62. In a number of variations, coolant 30 may bypass the engine 14 and leave the pump 30 through line 135 past the DMCP bypass valve 78 and meet coolant 30 from line 138 at junction 155 to enter the exhaust heat recover system 72. In a number of variations, the cooler coolant 30 from the cabin heater 60 may pass through a connecting line 118 to an engine oil heat exchanger valve 74. In a number of variations, the warmer coolant 30 leaving the EHRS 62 may be routed through line 134 to combine with the cooler coolant 30 from the cabin heater 60 at a secondary junction 152 which may include a secondary valve 82. In a number of variations, the combined coolant 30 from the secondary junction 152 may be routed through line 136 to an engine oil heat exchanger valve 74. In a number of variations, the engine oil heat exchanger valve 74 may be closed and the coolant 30 may be routed through line 126 through tertiary junction 160 and tertiary valve 84 to line 129 meet coolant 30 from the expansion tank 140 at intermediate junction 156 (including an intermediate valve 90), and line 132. In a number of variations, the engine oil heat exchanger valve 74 may be at least partially open and the coolant 30 may be routed through line 128 to the engine oil heat exchanger 64 and then the cooled coolant 30 may be routed through line 131 to a tertiary junction 160, which may include a tertiary valve 84. In a number of variations the coolant may then be routed through line 126 to meet coolant 30 from the expansion tank 140 at intermediate junction 156 (including an intermediate valve 90), and line 132. In a number of variations, the thermal management system 12 may further include a heat exchanger for axle oil 68, may be included and used to transfer heat to and from the coolant 30 and may further include an axle oil heat exchanger valve 79. In a number of variations, the axle oil heat exchanger 68 may be placed anywhere in the thermal management system 12 in the coolant circuit 100. In a number of variations, the exhaust gas from the engine 14 may enter the EHRS 62 through exhaust gas EHRS inlet line 200. In a number of variations, the exhaust gas may exit the EHRS 62 through exhaust gas EHRS outlet line 204. In a number of variations, the exhaust gas inlet line 200 may have an exhaust gas EHRS inlet valve 202. In a number of variations, the exhaust gas EHRS inlet valve 202 may allow for at least partial bypass of exhaust gas from the EHRS through exhaust gas EHRS bypass line 206. In a number of variations, transmission oil from the transmission 169 may enter and exit the transmission oil heat exchanger 66 through a transmission oil solenoid valve 83. In a number of variations, the transmission oil may exchange heat with coolant 30 in the transmission oil heat exchanger 66.

In a number of variations, the thermostat 54 and valves 70, 72, 74, 75, 76, 77, 78, 79, 80, 81, 82, 83, 84, 90, 202, and/or 154 may be at least partially opened and may control differing amounts of coolant 30 through the various components 14, 20, 22, 60, 62, 64, 66, 68, 56, 52, 140. In a number of variations, the valves 70, 72, 74, 75, 76, 77, 78, 79, 80, 81, 82, 83, 84, 90, 202, and/or 154 may be ball valves, butterfly valves, ceramic disc valves, check valves, choke valves, diaphragm valves, gate valves, globe valves, knife valves, needle valves, pinch valves, piston valves, plug valves, poppet valves, spool valves, thermal expansion valves, pressure reducing valves, combinations thereof, or may be another type. In a number of variations, the heat exchangers 66, 64 may be a double pipe, radiator, shell and tube, plate heat, plate and shell, adiabatic wheel, plate fin, pillow plate, fluid heat, dynamic scraped surface, or phase-change heat exchanger, combinations thereof, or may be another type. In a number of variations, all valves 70, 72, 74, 75, 76, 77, 78, 79, 81, 80, 82, 83, 84, 90, 202, and/or 154 may be a proportioning type valve which may allow full, partial, or no flow to the exit lines of the particular valve. In a number of variations, all valves 70, 72, 74, 75, 76, 77, 78, 79, 80, 81, 82, 83, 84, 90, 202, and/or 154 may be capable of being opened at a range from 0-100% and controls differing amounts of coolant through the various components 14, 20, 22, 60, 62, 64, 66, 68, 56, 52, 140, or may be another type. In this manner, the change of the flow to and from various components (14, 20, 22, 60, 62, 64, 66, 68, 56, 52, 140, or may be another type) could be over a period of time. In a number of variations, the ECU 42 may control the change of flow of coolant 30 through operation of these valves 70, 72, 74, 75, 76, 77, 78, 79, 80, 81, 82, 83, 84, 90, and/or 154 for optimal engine 14 performance on account of variables include but not limited to, engine temperature, engine pressure, engine performance, vehicle speed, vehicle fuel economy (i.e. MPG), cabin heater heat setting, radiator operation, transmission oil temperature and/or flowrate, engine oil temperature and/or flowrate, axle oil temperature and/or flowrate, exhaust heat recovery system 62 performance, or may be another variable. In a number of variations, the various components (14, 20, 22, 60, 62, 64, 66, 68, 56, 52, 140, or may be another type) could be in parallel or in series.

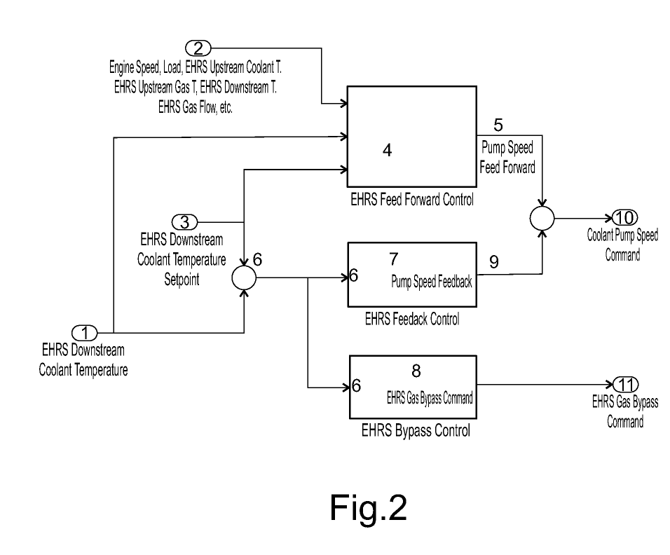

Referring to FIG. 2, in a number of variations, the ECU 42 may control the coolant 30 entering and exiting the exhaust heat recovery system 62 through manipulation of the exhaust heat recovery system valve 72, thermostat 54, coolant control valve 154, DMCP Bypass valve 78, secondary valve 82, and/or cabin heater valve 70. In a number of variations, the ECU 42 may take in through a sensor 170 a reading 1 on the exhaust heat recovery system (EHRS) 62 downstream coolant 30 temperature. In a number of variations, the ECU 42 may take in through sensors or CAN bus a reading 2 on the engine 14 speed, engine 14 load, exhaust heat recovery system (EHRS) 62 upstream coolant 30 temperature, EHRS upstream exhaust gas temperature, EHRS downstream exhaust gas temperature, and/or EHRS gas flowrate. In a number of variations, the ECU 42 may have a predetermined value for downstream coolant 30 temperature as set point 3 for coolant 30. This set point 3 may be determined by a first algorithm to best set the coolant 30 temperature exiting the EHRS 62 for minimize fuel usage, maximize engine efficiency and/or minimize heat waste. In a number of variations, this set point 3 may be 120° C. to avoid coolant boiling in and/or around EHRS 62. In a number of variations, these 3 variable inputs 1, 2, 3 may be feed into an EHRS 62 feed forward control 4. In a number of variations, the ECU 42 may determine a second algorithm based on these variable inputs 1, 2, 3 and set a pump 40 speed feed forward 5 to best control coolant 30 temperature downstream of the EHRS 62. In a number of variations, the feed forward 5 may take additional inputs based on energy balance of the EHRS 62 heat exchanger. In a number of variations, the feed forward may have additional inputs including, but not limited to, EHRS 62 exhaust gas flow rate, EHRS 62 upstream exhaust gas temperature, EHRS 62 downstream exhaust gas temperature, or EHRS 62 heat capacity of gas and coolant 30. In a number of variations, these inputs may be measured by a sensor (170) or may be estimated based on engine 14 speed and load. In a number of variations, the coolant 30 flowrate is translated to the coolant 30 pump 40 based on a pump flow characteristic map provided by these inputs. In a number of variations, a difference 6 may be found between the EHRS 62 downstream coolant 30 temperature set point 3 and the actual EHRS 62 downstream coolant 30 temperature. In a number of variations, this difference 6 may be an input into an EHRS Feedback Control 7. In a number of variations, the ECU 42 may determine a third algorithm based on this difference 6 and set a pump 40 speed feedback 9 to best control coolant 30 temperature downstream of the EHRS 62. In a number of variations, the pump 40 speed feed forward 4 and the pump 40 speed feedback 9 maybe combined to form a fourth algorithm and set a pump 40 speed command 10 to control the pump 40 speed to best control coolant 30 temperature downstream of the EHRS 62. In a number of variations, this pump 40 speed command 10 may also allow the ECU 42 to manipulate the exhaust heat recovery system valve 72, thermostat 54, coolant control valve 154, DMCP Bypass valve 78, secondary valve 82, and/or cabin heater valve 70 to control coolant 30 flow through the EHRS 62. In a number of variations, the difference 6 between the EHRS 62 downstream coolant 30 temperature set point 3 and the actual EHRS 62 downstream coolant 30 temperature may be an input into an EHRS 62 bypass control 8. In a number of variations, the ECU 42 may determine a fifth algorithm based on this difference 6 and set a EHRS 62 gas bypass command 11 to best control coolant 30 temperature downstream of the EHRS 62. In a number of variations, this command 11 may allow for exhaust gas from the engine 14 to bypass the EHRS 62 at least partially or altogether to keep coolant 30 below the set point 3. In a number of variations, this bypass of exhaust gas from the EHRS 62 may be done by at least partially closing valve 202 to route exhaust gas from the exhaust gas EHRS 62 inlet line 200 to exhaust gas EHRS 62 bypass line 206 which would bypass the EHRS 62 and the EHRS exhaust gas outlet line 204. In a number of variations, EHRS 62 bypass line 206 and EHRS exhaust gas outlet line 204 merge to form EHRS gas outlet line 208. In a number of variations, the ECU 42 and or valves 72, 54, 154, 78, 82, and/or 70 may limit coolant 30 temperature downstream of the EHRS 62 to below a setpoint e.g. 120° C. to prevent boiling of the coolant 30. In a number of variations, the ECU 42 and or valves 72, 54, 154, 78, 82, and/or 70 may allow the coolant to bypass the EHRS 62 to keep the coolant 30 temperature downstream of the EHRS to below 120° C. to prevent boiling of the coolant 30.

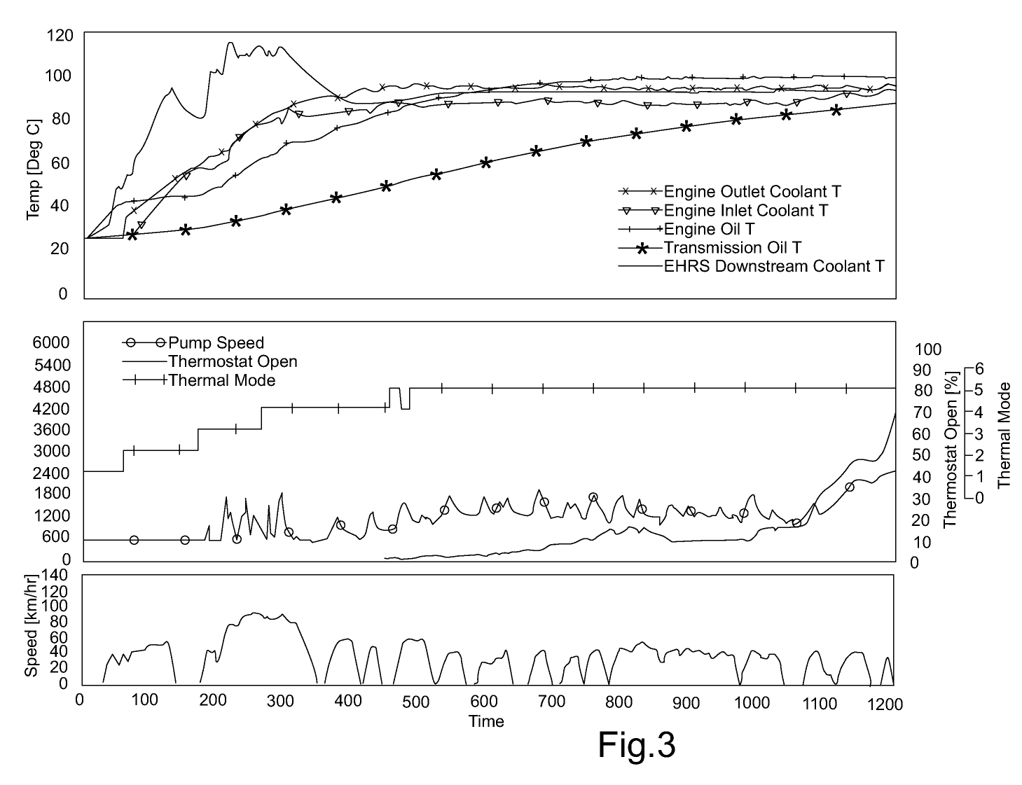

Referring to FIG. 3, a line graph of time vs. several variables of the thermal management is shown. In a number of variations, time vs. vehicle speed is shown. In a number of variations, time vs. pump 40 speed is shown. In a number of variations, time vs. pump 40 speed with thermostat open and/or in thermal mode is shown. In a number of variations, time vs. temperature of a fluid is shown. In a number of variations, the fluid may be the temperature of coolant 30 entering the engine 14 through the pump 40, the temperature of coolant 30 exiting the engine 14, the temperature of coolant 30 exiting the turbocharger 56, the temperature of the engine oil in a engine oil sump, the temperature of transmission oil in a transmission oil sump, the temperature of the coolant 30 exiting the exhaust heat recovery system 62, and the temperature of the coolant 30 entering the exhaust heat recover system 62 may be measured. In a number of variations, the vehicle speed may also be measured in FIG. 3.

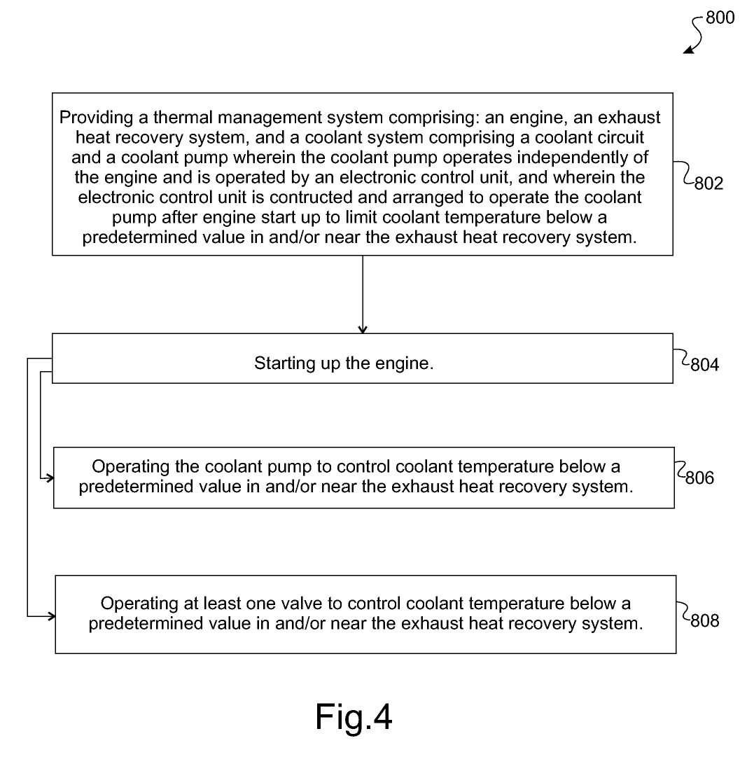

Referring to FIG. 4, in a number of variations may include a method 800 that may include in block 802 providing a thermal management system 12 comprising: an engine 14, an exhaust heat recovery system 62, and a coolant system 16 comprising a coolant circuit 100 and a coolant pump 40 wherein the coolant pump 40 operates independently of the engine and may be operated by an electronic control unit 42, and wherein the electronic control unit 42 may be constructed and arranged to operate the coolant pump 40 after engine start up to limit coolant 30 temperature below a predetermined value in and/or near the exhaust heat recovery system 62. In a number of variations, the method 800 may include in block 804 starting up the engine 14. In a number of variations, the method 800 may include in block 806 operating the coolant pump 40 and/or at least one valve 72, 54, 154, 78, 82, 74, and/or 70 to control coolant 30 temperature below a predetermined value in and/or near the exhaust heat recovery system 62. In a number of variations, optionally, the method 800 may include in block 808 operating at least one valve 72, 54, 154, 78, 82, 202, 74, and/or 70 to control coolant 30 temperature below a predetermined value in and/or near the exhaust heat recovery system 62.

In a number of variations, the coolant 30 flow in the thermal management system 12 may be rapidly warmed during start up by warm up of the cabin heater 60, exhaust heat recovery system 62, engine oil heat exchanger 64, axle oil heat exchanger 68 and/or transmission oil heat exchanger 66 components or may be a different component. By excluding cold coolant 30 from the engine 14 and radiator 52, the exhaust heat recovery system act on a smaller volume of coolant allowing faster heating of the components and/or allowing the engine 14 to be warmed internally. In a number of variations, the thermostat 54 and/or coolant control valve 154 may be controlled by the ECU 42 to send coolant 30 to the various components including the cabin heater 60, exhaust heat recovery system 62, engine oil heat exchanger 64, radiator 52, and/or transmission oil heat exchanger 66 components at different ratios for faster engine warm up, maintaining engine temperature, or prevention of engine overheating, depending on the needs and applications of the product 10. In a number of variations, the thermostat 54 may include the coolant control valve 154 as a multi-functional valve. In a number of variations, the ECU 42 may monitor product 10 conditions through sensors to operate the thermostat 54, coolant control valve 154 and/or other valves 70, 72, 74, 75, 76, 78, 77, 79, 80, 81, 82, 83, 84, and/or 90 to control the amount of coolant 30 to the various components including the cabin heater 60, exhaust heat recovery system 62, engine oil heat exchanger 64, axle oil heat exchanger 68 radiator 52, and/or transmission oil heat exchanger 66 or may be another component, to optimize the product 10 performance.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product including a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump after engine start up to limit coolant temperature below a predetermined value in and/or near the exhaust heat recovery system.

Variation 2 may include a product as set forth in Variations 1 wherein the electronic control unit limits coolant temperature below the predetermined value based on input of at least one condition determined by at least one sensor within the thermal management system.

Variation 3 may include a product as set forth in any of Variations 1-2 wherein the condition includes at least one of, engine speed, engine load, exhaust heat recovery system upstream coolant temperature, exhaust heat recovery system upstream gas temperature, exhaust heat recovery system downstream coolant temperature, exhaust heat recovery system downstream gas temperature, exhaust heat recovery system gas flowrate, or pump flowrate.

Variation 4 may include a product as set forth in any of Variations 1-3 wherein the predetermined value for coolant temperature is about 120° C.

Variation 5 may include a product as set forth in any of Variations 1-4 wherein the electronic control unit limits coolant temperature below the predetermined value based on a feed forward control from the exhaust heat recovery system.

Variation 6 may include a product as set forth in any of Variations 1-5 wherein the electronic control unit limits coolant temperature below the predetermined value based on a feedback control from the exhaust heat recovery system.

Variation 7 may include a product as set forth in any of Variations 1-6 wherein the electronic control unit limits coolant temperature below the predetermined value based on an exhaust gas bypass control from the exhaust heat recovery system.

Variation 8 may include a product as set forth in Variations 1-7 wherein the pump is an electric pump or dual mode coolant pump.

Variation 9 may include a product as set forth in any of Variations 2-8 wherein the thermal management system further comprises at least one heat exchanger.

Variation 10 may include a product as set forth in any of Variations 1-9 wherein the thermal management system further comprises a thermostat and a radiator and wherein the coolant circuit routes coolant through the radiator from the engine when the thermostat is open.

Variation 11 may include a method including providing a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump after engine start up to limit coolant temperature below a predetermined value in and/or near the exhaust heat recovery system; starting up the engine; and operating the coolant pump to limit coolant temperature below a predetermined value in and/or near the exhaust heat recovery system.

Variation 12 may include a method as set forth in Variation 11 wherein the electronic control unit limits coolant temperature below the predetermined value based on input of at least one condition determined by at least one sensor within the thermal management system.

Variation 13 may include a method as set forth in and of Variations 11-12 wherein the condition includes at least one of, engine speed, engine load, exhaust heat recovery system upstream coolant temperature, exhaust heat recovery system upstream gas temperature, exhaust heat recovery system downstream coolant temperature, exhaust heat recovery system downstream gas temperature, exhaust heat recovery system gas flowrate, or pump flowrate.

Variation 14 may include a method as set forth in any of Variations 11-13 wherein the predetermined value for coolant temperature is about 120° C.

Variation 15 may include a method as set forth in any of Variations 11-14 wherein the electronic control unit limits coolant temperature below the predetermined value based on a feed forward control from the exhaust heat recovery system.

Variation 16 may include a method as set forth in any of Variations 11-15 wherein the electronic control unit limits coolant temperature below the predetermined value based on a feedback control from the exhaust heat recovery system.

Variation 17 may include a method as set forth in any of Variations 11-16 wherein the electronic control unit limits coolant temperature below the predetermined value based on an exhaust gas bypass control from the exhaust heat recovery system.

Variation 18 may include a method as set forth in any of Variations 11-17 wherein the pump is an electric pump or dual mode coolant pump.

Variation 19 may include a method as set forth in any of Variations 12-18 wherein the thermal management system further comprises at least one heat exchanger.

Variation 20 may include a method as set forth in any of Variations 11-19 wherein the thermal management system further comprises a thermostat and a radiator and wherein the coolant circuit routes coolant through the radiator from the engine when the thermostat is open.

Variation 21 may include a method, and/or a product as set forth in any of Variations 1-20 wherein the thermal management system further includes sensors that acquire data regarding temperatures of fluids/components, pressures, speeds of fluids or components, and submits that data to the ECU for optimization of the system to minimize fuel usage, maximize engine efficiency and/or minimize heat waste.

Variation 22 may include a method, and/or a product as set forth in any of Variations 1-21 wherein the engine is an internal combustion engine, an external combustion engine, an electric motor, a hybrid engine, or may be another type.

Variation 23 may include a method, and/or a product as set forth in any of Variations 1-22 wherein the thermal management system further includes a cabin heater, a transmission oil heat exchanger, an engine oil heat exchanger, an axle oil heat exchanger, a cooling fan, a radiator, an expansion tank, and/or an exhaust heat recovery system.

Variation 24 may include a method, and/or a product as set forth in any of Variations 1-23 wherein the coolant includes at least one air, water, engine oil, transmission oil, axle oil, antifreeze (such as water and glycol), rust inhibitor, or a combination thereof.

Variation 25 may include a method, and/or a product as set forth in any of Variations 1-24 wherein the pump is an electric motor.

Variation 26 may include a method, and/or a product as set forth in any of Variations 1-25 wherein the thermal management system includes turbocharger and an intercooler for further cooling of the coolant in the coolant circuit.

Variation 26 may include a method, and/or a product as set forth in any of Variations 1-25 thermal management system further includes sensors that acquire data regarding temperatures of fluids/components, pressures, speeds of fluids or components, and submits that data to the ECU for optimization of the system to minimize fuel usage where the data includes at least one of engine speed, engine load, engine oil temperature and/or flowrate, engine coolant temperature and/or flowrate, axle oil temperature and/or flowrate, transmission fluid temperature and/or flowrate, engine pressure, engine performance, vehicle speed, vehicle fuel economy (i.e. MPG), cabin heater heat setting, radiator operation, or exhaust heat recovery system performance.

Variation 27 may include a method, and/or a product as set forth in any of Variations 1-26 wherein the ECU controls the change of flow of coolant through operation of the thermal management system valves based on the variables engine speed, engine load, engine oil temperature and/or flowrate, engine coolant temperature and/or flowrate, axle oil temperature and/or flowrate, transmission fluid temperature and/or flowrate, engine pressure, engine performance, vehicle speed, vehicle fuel economy (i.e. MPG), cabin heater heat setting, radiator operation, or exhaust heat recovery system performance.

Variation 28 may include a method, and/or a product as set forth in any of Variations 1-27 the thermostat and valves are capable of being opened at a range from 0-100% and controls differing amounts of coolant and/or exhaust gas through the various components.

Variation 29 may include a method, and/or a product as set forth in any of Variations 1-28 wherein the valves are ball valves, butterfly valves, ceramic disc valves, check valves, choke valves, diaphragm valves, gate valves, globe valves, knife valves, needle valves, pinch valves, piston valves, plug valves, poppet valves, spool valves, thermal expansion valves, pressure reducing valves, or combinations thereof.

Variation 30 may include a method, and/or a product as set forth in any of Variations 1-29 wherein the at least one heat exchanger is a double pipe, radiator, shell and tube, plate heat, plate and shell, adiabatic wheel, plate fin, pillow plate, fluid heat, dynamic scraped surface, or phase-change heat exchanger, or combinations thereof.

Variation 31 may include a method, and/or a product as set forth in any of Variations 1-30 wherein the thermostat includes the coolant control valve as a multi-functional valve.

Variation 32 may include a method, and/or a product as set forth in any of Variations 1-31 wherein the ECU controls coolant flow to the various components including the cabin heater, EHRS, engine oil heat exchanger, transmission oil heat exchanger, radiator, axle oil heat exchanger, or turbocharger based on conditions within the thermal management system.

The above description of select examples of the invention is merely exemplary in nature and, thus, variations or variants thereof are not to be regarded as a departure from the spirit and scope of the invention.

What is claimed is:

1. A product comprising: a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump after engine start up to limit coolant temperature below a predetermined value in and/or near the exhaust heat recovery system.

2. A product as set forth in claim 1 wherein the electronic control unit limits coolant temperature below the predetermined value based on input of at least one condition determined by at least one sensor within the thermal management system.

3. A product as set forth in claim 2 wherein the condition includes at least one of, engine speed, engine load, exhaust heat recovery system upstream coolant temperature, exhaust heat recovery system upstream gas temperature, exhaust heat recovery system downstream coolant temperature, exhaust heat recovery system downstream gas temperature, exhaust heat recovery system gas flowrate, or pump flowrate.

4. A product as set forth in claim 1 wherein the predetermined value for coolant temperature is about 120° C.

5. A product as set forth in claim 1 wherein the electronic control unit limits coolant temperature below the predetermined value based on a feed forward control from the exhaust heat recovery system.

6. A product as set forth in claim 1 wherein the electronic control unit limits coolant temperature below the predetermined value based on a feedback control from the exhaust heat recovery system.

7. A product as set forth in claim 1 wherein the electronic control unit limits coolant temperature below the predetermined value based on an exhaust gas bypass control from the exhaust heat recovery system.

8. A product as set forth in claim 1 wherein the pump is an electric pump or dual mode coolant pump.

9. A product as set forth in claim 1 wherein the thermal management system further comprises at least one heat exchanger.

10. A product as set forth in claim 1 wherein the thermal management system further comprises a thermostat and a radiator and wherein the coolant circuit routes coolant through the radiator from the engine when the thermostat is open.

11. A method comprising: providing a thermal management system comprising: an engine, an exhaust heat recovery system, and a coolant system comprising a coolant circuit and a coolant pump wherein the coolant pump operates independently of the engine and is operated by an electronic control unit, and wherein the electronic control unit is constructed and arranged to operate the coolant pump after engine start up to limit coolant temperature below a predetermined value in and/or near the exhaust heat recovery system;
starting up the engine; and
operating the coolant pump to limit coolant temperature below a predetermined value in and/or near the exhaust heat recovery system.

12. A method as set forth in claim 11 wherein the electronic control unit limits coolant temperature below the predetermined value based on input of at least one condition determined by at least one sensor within the thermal management system.

13. A method as set forth in claim 12 wherein the condition includes at least one of, engine speed, engine load, exhaust heat recovery system upstream coolant temperature, exhaust heat recovery system upstream gas temperature, exhaust heat recovery system downstream coolant temperature, exhaust heat recovery system downstream gas temperature, exhaust heat recovery system gas flowrate, or pump flowrate.

14. A method as set forth in claim 11 wherein the predetermined value for coolant temperature is about 120° C.

15. A method as set forth in claim 11 wherein the electronic control unit limits coolant temperature below the predetermined value based on a feed forward control from the exhaust heat recovery system.

16. A method as set forth in claim 11 wherein the electronic control unit limits coolant temperature below the predetermined value based on a feedback control from the exhaust heat recovery system.

17. A method as set forth in claim 11 wherein the electronic control unit limits coolant temperature below the predetermined value based on an exhaust gas bypass control from the exhaust heat recovery system.

18. A method as set forth in claim 11 wherein the pump is an electric pump or dual mode coolant pump.

19. A method as set forth in claim 11 wherein the thermal management system further comprises at least one heat exchanger.

20. A method as set forth in claim 11 wherein the thermal management system further comprises a thermostat and a radiator and wherein the coolant circuit routes coolant through the radiator from the engine when the thermostat is open.
